(19) United States
(12) Patent Application Publication
(10) Pub. No.: US 2009/0079673 A1
(43) Pub. Date: Mar. 26, 2009

(54) PLASMA DISPLAY PANEL DEVICE

(75) Inventors: Ju Won SEO, Gumi-si (KR); Yun Kwon JUNG, Gumi-si (KR)

Correspondence Address: FISH & RICHARDSON P.C., P.O. BOX 1022, MINNEAPOLIS, MN, 55440-1022, US

(73) Assignee: LG ELECTRONICS INC., Seoul (KR)

(21) Appl. No.: 12/211,836

(22) Filed: Sep. 17, 2008

(30) Foreign Application Priority Data
Sep. 21, 2007 (KR) 10-2007-0096904

(51) Int. Cl. G09G 3/28

(52) U.S. Cl. 345/60

(57) ABSTRACT

The present invention relates to a plasma display device. The plasma display device includes a plasma display panel including an upper substrate having a scan electrode and a sustain electrode, and a lower substrate having a barrier rib for dividing discharge cells, and a driver disposed at one side of the plasma display panel and applying a driving signal to the scan electrode and the sustain electrode. At least one of the scan electrode and the sustain electrode includes a first electrode unit extending on the barrier rib from the driver to a non display area disposed at the other side of the plasma display panel, and a second electrode unit connected to the first electrode unit and extending from the non display area to the driver on discharge cells that are adjacent to an upper side and a lower side of the barrier rib. Current flows in the scan electrode and the sustain electrode in opposite directions on the discharge cells. Therefore, it is possible to reduce brightness deviation between discharge cells adjacent to the driver and another discharge cells adjacent to the non display area.

This Nonprovisional application claims priority under 35 U.S.C. § 119(a) on Patent Application No. 10-2007-0096904 filed in Korea on Sep. 21, 2007, the entire contents of which are hereby incorporated by reference.

### BACKGROUND OF THE INVENTION

1. Field of the Invention

The present invention relates to a plasma display device for reducing brightness deviation during discharge in a plasma display panel.

2. Description of the Background Art

In general, a plasma display device (PDP) is a flat panel display for displaying images using plasma discharge. Since the plasma display device has a fast response speed and a wide display area, the plasma display device has been widely used as a high definition television, a monitor, and a display device for indoor and outdoor advertisement.

The plasma display device includes m×n discharge cells disposed in a matrix and connected to at least one of a scan electrode, a sustain electrode, and an address electrode.

The plasma display device includes at least one of a scan electrode and a sustain electrode, which is divided into the right and the left of a front panel, and a scan driving board and a sustain driving board for applying a driving signal to the scan electrode and the sustain electrode, respectively.

Lately, there have been many studies made for integrating the scan driving board and the sustain driving board of the plasma display device, and there have been many studies also made for changing locations and shapes of at least one of the scan electrode and the sustain electrode for integrating the scan driving board and the sustain driving board.

### SUMMARY OF THE INVENTION

Accordingly, an aspect of the present invention is to solve at least the problems and disadvantages of the background art. In accordance with an aspect of the present invention, a plasma display device comprises a plasma display panel and a driver. The plasma display panel includes an upper substrate having a scan electrode and a sustain electrode, and a lower substrate having a barrier rib for dividing discharge cells. The driver is disposed at one side of the plasma display panel and applies a driving signal to the scan electrode and the sustain electrode. At least one of the scan electrode and the sustain electrode includes a first electrode unit extending on the barrier rib from the driver to a non display area disposed at the other side of the plasma display panel, and a second electrode unit connected to the first electrode unit and extending from the non display area to the driver on discharge cells that are adjacent to an upper side and a lower side of the barrier rib. Here, current flows in the scan electrode and the sustain electrode in opposite directions on the discharge cells.

In accordance with another aspect of the present invention, a plasma display device comprises a plasma display panel including an upper substrate having a scan electrode and a sustain electrode and a lower substrate having a barrier rib dividing discharge cells, and a driver disposed at one side of the plasma display panel and applying a driving signal to the scan electrode and the sustain electrode. The scan electrode and the sustain electrode include a first electrode unit extending from the driver to a non display area disposed at the other side of the plasma display panel, and a second electrode unit connected to the first electrode unit and extending from the non display area to the driver. Here, current flows in the scan electrode and the sustain electrode in opposite directions on the discharge cells.

In accordance with another aspect of the present invention, a plasma display device includes a plasma display panel including an upper substrate having a scan electrode and a sustain electrode and a lower substrate having a barrier rib for dividing discharge cells, and a driver disposed at one side of the plasma display panel and applying a driving signal to the scan electrode and the sustain electrode. At least one of the scan electrode and the sustain electrode includes a first electrode unit extending from the driver to a non display area disposed at the other side of the plasma display panel, and a second electrode unit connected to the first electrode unit and extending from the non display area to the driver. Two sustain electrodes are continuously disposed between two adjacent scan electrodes, and current flows in the scan electrode and the sustain electrode in opposition directions on the discharge cells.

### BRIEF DESCRIPTION OF THE DRAWINGS

The present invention will become more fully understood from the detailed description given herein below and the accompanying drawings, which are given by illustration only, and thus are not limitative of the present invention, and wherein:

FIG. 1 is a perspective view of a plasma display panel in accordance with the first embodiment of the present invention;

FIG. 2 is a diagram illustrating electrode arrangement of a plasma display panel in accordance with the first embodiment of the present invention;

FIG. 3 is a timing diagram of a time division driving method for driving a plasma display panel by dividing one frame into a plurality of subfields;

FIG. 4 is a timing diagram illustrating driving signals for driving a plasma display panel for the divided one subfield in accordance with the first embodiment of the present invention;

FIG. 5 is a perspective view illustrating a plasma display device in accordance with the first embodiment of the present invention;

FIG. 6 is a layout illustrating modules of a plasma display device in accordance with the first embodiment of the present invention;

FIG. 7 is a perspective view illustrating electrode arrangement of a plasma display device in accordance with the first embodiment of the present invention;

FIG. 8 is a magnified view of a first block A of FIG. 7 in accordance with the first embodiment of the present invention;

FIG. 9 is a magnified view of a first block of FIG. 7 in accordance with the second embodiment of the present invention;

FIG. 10 is a magnified view of the first block of FIG. 7 in accordance with the third embodiment of the present invention;

FIG. 11 is a magnified view of the first block of FIG. 7 in accordance with the fourth embodiment of the present invention;

FIG. 12 is a perspective view illustrating electrode arrangement of a plasma display device in accordance with the second embodiment of the present invention;

FIG. 13 is a magnified view of a second block B of FIG. 12 in accordance with the first embodiment of the present invention;

FIG. 14 is a magnified view of a second block B of FIG. 12 in accordance with the second embodiment of the present invention;

FIG. 15 is a perspective view illustrating electrode arrangement of a plasma display device in accordance with the third embodiment of the present invention;

FIG. 16 is a magnified view of a third block C of FIG. 15 in accordance with the first embodiment of the present invention;

FIG. 17 is a perspective view illustrating electrode arrangement of a plasma display device in accordance with the fourth embodiment of the present invention; and

FIG. 18 is a magnified view of a fourth block D of FIG. 17 in accordance with the first embodiment of the present invention.

### DETAILED DESCRIPTION OF PREFERRED EMBODIMENTS

Preferred embodiments of the present invention will be described in a more detailed manner with reference to the drawings.

It is an object of the present invention to provide a plasma display device for reducing brightness deviation during discharge in a plasma display panel.

Hereinafter, a plasma display device will be described in detail with reference to the drawings in accordance with an embodiment of the present invention.

A plasma display device according to the present invention may include a plurality of exemplary embodiments. Hereinafter, preferable embodiments thereof will be described.

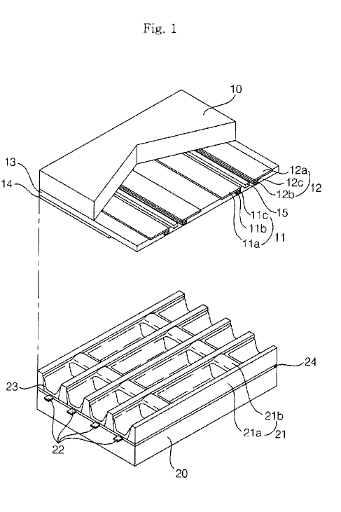

FIG. 1 is a perspective view of a plasma display panel in accordance with the first embodiment of the present invention.

As shown in FIG. 1, the plasma display panel includes a pair of sustain electrodes formed on an upper substrate 10, which is a scan electrode 11 and a sustain electrode 12, and an address electrode 22 formed on a lower substrate 20.

The pair of sustain electrodes 11 and 12 includes transparent electrodes 11a and 12a made of Indium-Tin-Oxide (ITO) and bus electrodes 11b and 12b. The bus electrodes 11b and 12b may be made of metals such as silver (Ag) or Chrome (Cr), stacked metal of Chrome/Copper/Chrome (Cr/Cu/Cr), or stacked metal of Chrome/Aluminum/Chrome (Cr/Al/Cr). The bus electrodes 11b and 12b are formed on the transparent electrodes 11a and 12a for reducing voltage drop caused by the high resistive transparent electrodes 11a and 12a.

According to the first embodiment of the present invention, a pair of sustain electrodes 11 and 12 may be made only of the bus electrodes 11b and 12b without the transparent electrodes 11a and 12a as well as the stacking of the transparent electrodes 11a and 12a and the bus electrodes 11b and 12b. Since the transparent electrodes 11a and 12a are used in the present embodiment, it is possible to reduce the manufacturing cost of the plasma display panel. The bus electrodes 11b and 12b may be made of various materials such as phosphor material as well as the above described materials.

A black matrix (BM) 15 is disposed between the transparent electrodes 11a and 12a and the bus electrodes 11b and 11c of the scan electrode 11 and the sustain electrodes 11a 12a. The black matrix 15 blocks light for reducing reflection by absorbing external light generated from the outside and improves the purity and the contrast of the upper substrate 10.

The black matrix 15 according to the first embodiment is formed on the upper substrate 10. The black matrix 15 includes a first black matrix 15 overlapping with a barrier rib 21 and second black matrices 11C and 12C formed between the transparent electrodes 11a and 12a and the bus electrodes 11b and 12b, respectively. Here, the first black matrix 15 and the second black matrices 11c and 12c, which are referred as a black layer or a black electrode layer, may be physically connected to each other because they are formed at the same time. Or, the first black matrix 15 and the second black matrixes 11c and 12c may be not physically connected because they are not formed at the same time.

If they are physically connected, the first black matrix 15 and the second black matrices 11c and 12c may be made of the same material. However, if they are physically separated, the first black matrix 15 and the second black matrices 11c and 12c may be made of different materials.

An upper dielectric layer 13 and a passivation layer 14 are stacked on the upper substrate 10 having the scan electrode and the sustain electrode 12 formed in parallel. Charged particles, generated by discharge, are stacked on the upper electrode layer 13 for protecting the pair of sustain electrodes 11 and 12. The passivation layer 14 protects the upper dielectric layer 13 from the sputtering of charged particles during gas discharge and improves the emission efficiency of secondary electron.

The address electrode 22 is formed in a direction that crosses the scan electrode 11 and the sustain electrode 12. Also, a lower dielectric layer 23 and a barrier rib 21 are formed on the lower substrate 20 having the address electrode 22 formed thereon.

A phosphor layer 23 is formed on the lower dielectric layer 23 and the barrier rib 21. The barrier rib 21 includes a vertical barrier rib 21a and a horizontal barrier rib 21b in a closed structure. The barrier rib 21 physically divides discharge cells and prevents ultraviolet rays and visible rays generated by discharge from leaking to adjacent discharge cells.

Although the barrier rib 21 is described to have the structure show in FIG. 1 in the first embodiment of the present invention, the barrier rib 21 may have various structures. For example, the barrier rib 21 may have a differential barrier rib structure where the heights of the vertical barrier rib 21a and the horizontal barrier rib 21b are different, a channel type barrier rib structure where at least one of the vertical barrier rib 21a and the horizontal barrier rib 21b is used as a ventilation path, or a hollow barrier rib structure where at least one of the vertical barrier rib 21a and the horizontal barrier rib 21b has a hollow.

In case of the differential barrier rib structure, it is preferable that the height of the vertical barrier rib 21b is higher than that of the horizontal barrier rib 21b. In case of the channel barrier rib structure of the hollow barrier rib structure, it is preferable that the channel or the hollow is formed on the horizontal barrier rib 21b.

Although R, G, and B discharge cells are disposed at the same line in the first embodiment of the present invention, the R, G, and B discharge cells may be disposed in different forms. For example, the R, G, and B discharge cells may be formed in a triangle which is referred as a delta type. Also, the discharge cell may have not only a rectangular shape but also various polygons such as a pentagon and a hexagon.

Also, the phosphor layer 23 radiates one of red, green, and blue visible rays which are radiated by the ultraviolet rays generated during gas discharge. An inert mixed gas is inserted in a discharge space prepared between the upper/lower substrates 10 and 20 and the barrier rib 21. Here, the inert mixed gas may be He+Xe, Ne+Xe, and He+Ne+Xe.

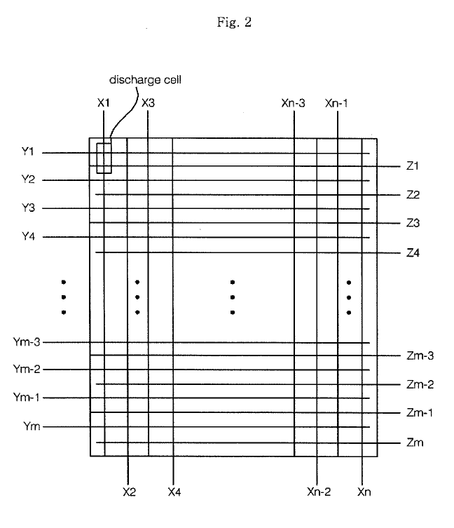

FIG. 2 is a diagram illustrating electrode arrangement of a plasma display panel in accordance with the first embodiment of the present invention. It is preferable that a plurality of cells forming a plasma display panel may be disposed in matrix as shown in FIG. 2. Each of the plurality of cells is disposed at corresponding crossing of scan electrode lines Y1 to Ym, sustain electrode lines Z1 to Zm, and address electrode lines X1 to Xn. The scan electrode lines Y1 to Ym may be sequentially driven or driven at the same time. The sustain electrode lines Z1 to Zm may be driven at the same time. The address electrode lines X1 to Xn may be driven by being divided into odd number lines and even number lines, or sequentially driven.

Since the electrode arrangement of FIG. 2 is only the first embodiment of the present invention, the present invention is not limited to the electrode arrangement shown in FIG. 2 and the driving method thereof. For example, a dual scan method may be used. In the dual scan method, two scan electrode lines among the scan electrode lines Y1 to Ym are scanned at the same time. Also, the address electrode lines X1 to Xn may be driven by being divided into the upper and lower sides from the center of the panel.

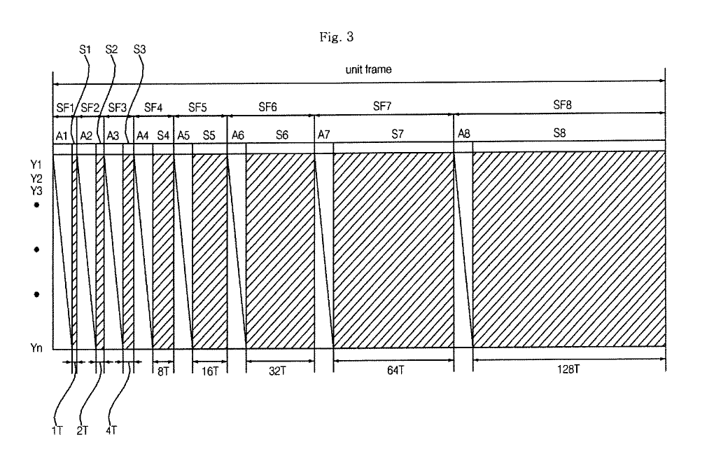

FIG. 3 is a timing diagram of a time division driving method for driving a plasma display panel by dividing one frame into a plurality of subfields. The unit frame may be divided into a predetermined number of subfields, for example, eight subfields SF1 to SF, for realizing time division gray scale display. Also, each subfield SF1 to SF8 may be divided into a reset period (not shown), address periods A1 to A8, and sustain periods S1 to S8.

According to the first embodiment, a reset period may be omitted from at least one of a plurality of subfields. For example, a reset period may be present at an initial subfield only or present only at the initial subfield and a predetermined middle subfield among entire subfields.

At each of the address periods A1 to A8, a display data signal is applied to an address electrode X, and a scan pulse is sequentially applied to each of corresponding scan electrode Y.

At each of the sustain periods S1 to S8, the sustain pulse is alternatively applied to the scan electrode Y and the sustain electrode Z. Therefore, sustain discharge is induced at discharge cells that induce wall charge in the address periods A1 to A8.

The brightness of the plasma display panel is in proportional to the number of sustain discharge pulses in the sustain discharge periods S1 to S8 of the unit frame. If one frame that forms one image is expressed with 8 subfields and 256 gray scales, different numbers of sustain pulses may be assigned to each subfield in rates of 1, 2, 4, 6, 8, 16, 32, 64, and 128. In order to obtain the brightness of 133 gray scale, sustain discharge is induced by addressing cells for a first subfield period, a third sustain field, and the eighth sustain field.

The number of sustain discharges allocated to each subfield may be variably decided according to the weight of each subfield in an automatic power control (APC) step. That is, although one frame is divided into eight subfields in FIG. 3, the present invention is not limited thereto. The number of subfields forming one frame may be changed according to design specification. For example, a plasma display panel can be driven by dividing one frame into more than eight subfields such as 12 or 16 subfields.

It is possible to change the number of sustain discharges allocated to each subfield in consideration of gamma characteristic and panel characteristics. For example, it is possible to reduce a gray scale allocated to the fourth subfield from 8 to 6 and to increase a gray scale allocated to the sixth subfield from 32 to 34.

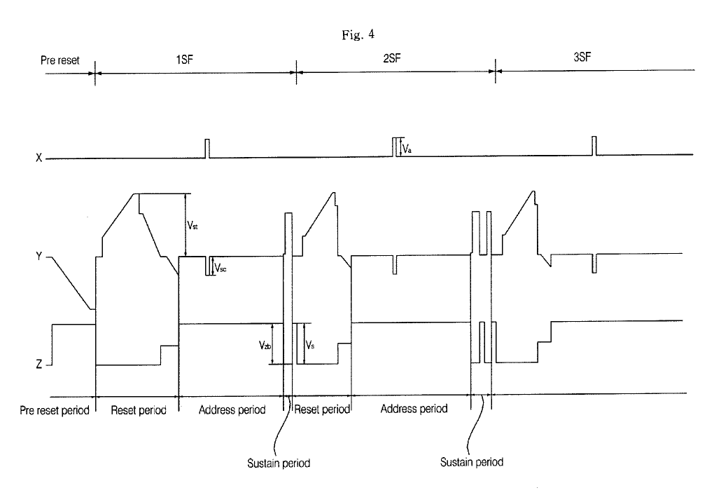

FIG. 4 is a timing diagram illustrating driving signals for driving a plasma display panel in the divided one subfield in accordance with the first embodiment of the present invention.

The subfield includes a pre reset period for forming a positive wall charge on the scan electrodes Y and forming a negative wall charge on the sustain electrodes Z, a reset period for initializing discharge cells in an entire screen using wall charge distribution formed in the pre reset period, an address period for selecting a discharge cell, and a sustain period for sustaining discharge of the selected discharge cells.

The reset period includes a setup period and a set-down period. At the setup period, a micro discharge is induced at all of the discharge cells by applying a ramp up waveform (Ramp-up) to all of the scan electrodes at the same time, thereby inducing a wall charge. At the set-down period, an erase discharge is induced at all of the discharge cells by applying a ramp down waveform to all of the scan electrode Y at the same time, thereby erasing unnecessary wall charge and space charge which are generated by the setup discharge. Here, the ramp down waveform is a waveform that falls from a positive voltage lower than a peak voltage of the ramp up waveform.

In the address period, a scan signal having a negative polarity is sequentially applied to the scan electrode. At the same time, a data signal having a positive voltage Va is applied to the address electrode X. Finally, a predetermined cell is selected by an address discharge that is induced by the voltage difference between the scan signal and the data signal and the wall voltage generated during the reset period. Meanwhile, a signal for sustaining sustain voltage is applied to the sustain electrode for the set down period and the address period.

In the sustain period, a sustain discharge is generated as a surface discharge between a scan electrode and a sustain electrode by alternatively applying a sustain pulse having a sustain voltage to the scan electrode and the sustain electrode.

The driving waveforms shown in FIG. 4 are only the first embodiment of signals for driving a plasma display panel. Therefore, the present invention is not limited thereto. For example, the pre reset period may be omitted. Also, the polarity and the voltage level of the driving signals shown in FIG. 4 may be changed if it is necessary, and an erase signal for erasing a wall charge may be applied to the sustain electrode after completely ending the sustain discharge. Furthermore, it is also possible to perform a single sustain driving method for inducing a sustain discharge by applying the sustain signal to only one of the scan electrode Y and the sustain electrode Z.

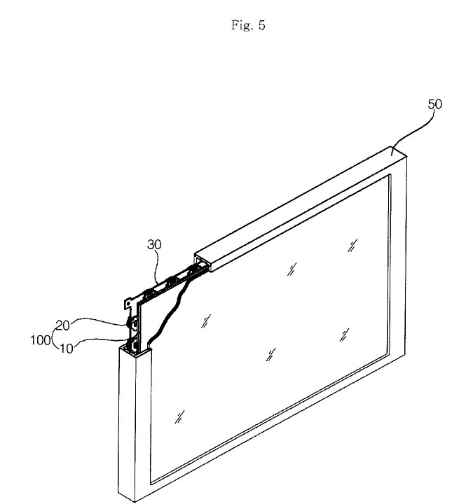

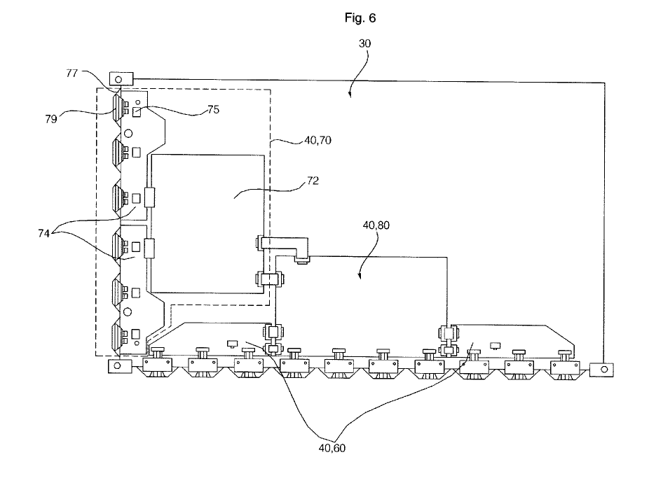

FIG. 5 is a perspective view illustrating a plasma display device in accordance with the first embodiment of the present invention, and FIG. 6 is a layout illustrating modules of a plasma display device in accordance with the first embodiment of the present invention.

As shown in FIG. 5 and FIG. 6, the plasma display device according to the first embodiment includes a plasma display panel 100 with an inert mixed gas charged for radiating visible rays by electrons discharged when current is applied to the inert mixed gas, a heat sink plate 30 attached at a rear side of the plasma display panel 100, a printed circuit board 40 disposed at a rear side of the heat sink plate 30, and a case 50 disposed at edges of the plasma display panel 100 for covering the heat sink plate 30.

The plasma display panel 100 includes an upper substrate 10 exposed to a user, a lower substrate 20 disposed at a rear side of the upper substrate 10, and an inert mixed gas (not shown) charged inside the upper and lower substrates 10 and 20.

The plasma display panel 100 also includes a plurality of scan electrodes (not shown), a plurality of sustain electrodes (not shown) facing the scan electrodes, a plurality of address electrodes (not shown) disposed in a direction that crosses the scan electrodes, and a phosphor member (not shown) coated on the inside of the plasma display panel 100 and generating visible rays by discharge induced when current is applied between the scan electrode and the address electrode.

That is, in the plasma display device according to the present embodiment, a module is constituted of a plasma display panel 100, a heat sink 300, and a printed circuit board 40, and a case 50 is disposed to surround the outer side of the module.

The heat sink 30 is disposed at the rear side of the plasma display panel 100. The heat sink 30 supports the plasma display panel 100, absorbs heat generated from the plasma display panel 100, and discharges the absorbed heat.

The printed circuit board 40 is disposed at the rear side of the heat sink 30 and applies the current to the plasma display panel 100.

The printed circuit board 40 includes a data driver board 60 for applying a data signal to the address electrode of the plasma display panel 100, an integrated driving board 70 for applying a driving signal to the scan electrode and the sustain electrode, a main controller 80 for controlling the data driver board 60 and the integrated driving board 70, and a power supply (not shown) for supplying power to each of the boards 60, 70, and 80.

That is, the data driver board 60 selects discharge cells from a plurality of discharge cells (not shown) formed on the plasma display panel 100 by applying the data signal to the address electrode formed on the plasma display panel 100.

Here, the data driver board 60 may be disposed at one of an upper side and a lower side of the plasma display panel 100 or at both of the upper side and the lower side thereof according to the single scan method or the dual scan method.

The data driver board 60 is connected to the main controller 80 and applies a data signal to the address electrode.

The data driver board 60 includes a data IC (not shown) for controlling current applied to the address electrode. The data IC performs switching in order to control the applied current.

Referring to FIG. 6, the integrated driving board 70 includes an integrated board 72 connected to the main controller 80, and an integrate driver board 74 connected to the plasma display panel 100.

The integrated board 72 is disposed at one side edge of the rear side of the plasma display panel 100. The integrated board 72 generates and outputs a driving signal to the scan electrode and the sustain electrode.

The integrated driver board 74 is disposed by being divided into an upper and a lower part in the present embodiment. Unlike the present embodiment, the integrated driver board 74 may be disposed as a single unit or disposed by being divided further more parts.

The integrated driver board 74 includes a scan IC 75 for supplying current to the scan electrode of the panel 100. The scan IC 75 continuously applies a reset signal, a scan signal, and a sustain signal to the scan electrode and the sustain electrode.

The integrated driving board 70 further includes an electrode pad 77 disposed at one side of the plasma display panel 100 and applying the generated driving signal to the scan electrode and the sustain electrode and a coupling member 79 for transferring the driving signal to the electrode pad 77.

The electrode pad 77 has one side connected to the scan electrode and the sustain electrode and the other side connected to one side of the coupling member 79. The electrode pad 77 receives the driving signal.

The coupling member 79 includes one side connected to the electrode pad 77 and the other connected to the scan IC 75. The coupling member 79 applies the driving signal of the integrated board 72 to the electrode pad 77.

The coupling member 79 may be a flexible printed circuit (FPC), a tape carrier package (TCP), a chip on FPC (COF), and a flat flexible cable (FFC) in order to apply a driving signal to the scan electrode and the sustain electrode according to the switching operation of the scan IC 75.

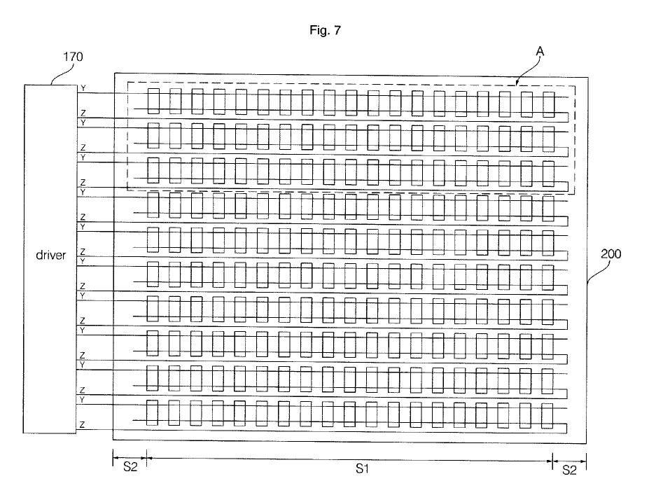

FIG. 7 is a perspective view illustrating electrode arrangement in a plasma display device in accordance with the first embodiment of the present invention.

As shown in FIG. 7, the plasma display device according to the present embodiment includes a plasma display panel 200 and a driver 170. The plasma display panel 200 include an upper substrate having a scan electrode Y and a sustain electrode Z. The driver 170 is disposed at one side of the plasma display panel 200 and applies the driving signal to the scan electrode Y and the sustain electrode Z.

The driver 170 shown in FIG. 7 is equivalent to the integrated driving board 70 shown in FIG. 6, which has the printed circuit board 40. Hereinafter, it is referred as the driver 170.

The driver 170 is disposed at the rear side of the plasma display panel 200. FIG. 7 is a plane view of the driver 170.

The driver 170 is formed at one side of the plasma display panel 200 and applies a driving signal to the scan electrode Y and the sustain electrode Z.

The plasma display panel 200 includes a display area S1 where an image is displayed and a non display area S2 where an image is not displayed. The non display area S2 surrounds the display area S1.

One of the scan electrode Y and the sustain electrode Z extends on the barrier rib from the driver 170 formed at one side of the plasma display panel 200 to a non display area S2 disposed at the other side thereof, bends at the non display area S2, and extends again on discharge cells adjacent to the upper side or the lower side of the barrier rib.

That is, current flows in the scan electrode Y and the sustain electrode Z in different directions on discharge cells adjacent to the upper side or the lower side of the barrier rib.

In other words, if a direction of current flow in the scan electrode Y is from the driver 170 disposed one side to the non display area S2 disposed at the other side thereof on the discharge cells adjacent to the upper side or the lower side of the barrier rib, a direction of current flow in the sustain electrode Z is from the non display area S2 disposed at the other side to the driver 170 disposed at one side.

Such electrode arrangement of the scan electrode Y and the sustain electrode Z can reduce brightness deviation between a discharge cell adjacent to the driver 170 disposed at one side and another discharge cell adjacent to the non display area S2 disposed at the other side.

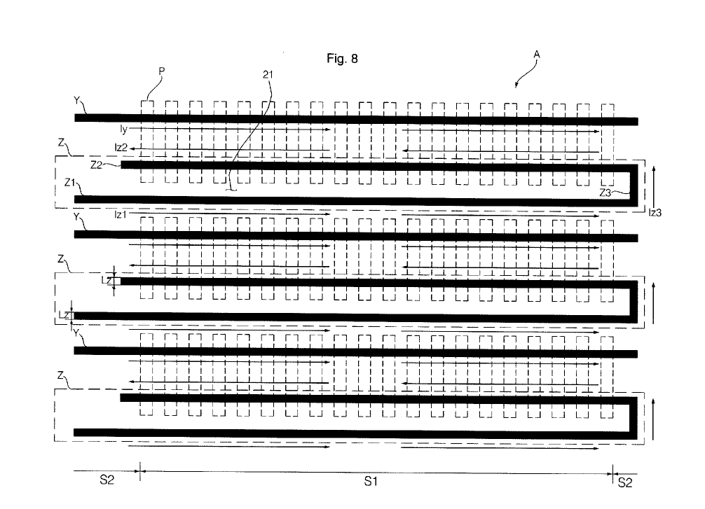

FIG. 8 is a magnified view of a first block A of FIG. 7 in accordance with the first embodiment of the present invention.

As shown in FIG. 7 and FIG. 8, the plasma display panel 200 includes a scan electrode Y extending on a discharge cell P from a driver 170 disposed at one side thereof to a non display area S2 disposed at the other side, and a sustain electrode Z that extends on the barrier rib 21 from the driver 170 to the non display area S2 disposed at the other side, bends at the non display area S2, and extends again on the discharge cell P adjacent to an upper side of the barrier rib 21 to the driver 170.

That is, the sustain electrode Z includes a first electrode unit Z1 extending on the barrier rib 21 from the driver 170 disposed at one side to the non display area S2 disposed at the other side, a second electrode unit Z2 extending on the discharge cell P adjacent to the upper side of the barrier rib 21 from the non display area S2 to the driver 170, and a coupling member Z3 for connecting the first and second electrode units Z1 and Z2.

The driver 170 applies a scan electric current ly to the scan electrode Y and a sustain current lz to the sustain electrode Z.

The sustain current lz includes a first sustain lz1 flowing to the first electrode Z1, a second sustain current lz2 flowing to the second electrode unit z2, and a third sustain current lz2 flowing to the coupling member z3.

That is, although the sustain current lz was described to include the first, second, and third sustain current lz1, lz2, and lz3 for convenience, the first, second, and third sustain current lz1, lz2, and lz3 are the sustain current lz.

The first, second, and third sustain currents lz1, lz2, and lz3 flow in different directions, and the first sustain current lz1 flows in the same direction of the scan electric current ly.

Therefore, the second sustain current lz2 flows in the opposite direction of the scan electrode ly.

The scan electrode Y is formed to substantially have a width identical to the width LZ of the sustain electrode Z, and the width of the first electrode unit Z1 is substantially identical to the width of the second electrode unit Z2.

The electrode arrangement of the scan electrode Y and the sustain electrode Z has a Y-ZZ-Y structure, and the electrode arrangement of the discharge cell P has a Y-Z structure.

Here, the scan electrode Y and the sustain electrode Z are formed to substantially have the same brightness, and a bus electrode, a transparent electrode, and a black matrix are formed at the scan electrode Y and the second electrode unit Z2 of the sustain electrode Z, respectively.

Also, the bus electrode and the black matrix may be also formed at the first electrode Z1 of the sustain electrode Z.

Although the sustain electrode Z is shown in FIG. 8 to have the second electrode unit Z2 extending on a discharge cell P adjacent to the upper side of the barrier rib 21, the second electrode Z2 may extends on a discharge cell adjacent to a lower side of the barrier rib 21.

Although the sustain electrode Z is shown in FIG. 8 to have the first, second electrodes units Z1 and Z2, and the coupling member 23, the scan electrode Y may also have first and second electrode units and a coupling member.

That is, one of the scan electrode Y and the sustain electrode Z may include the first and second electrode units and the coupling unit, and the other may be formed without bending. Also, the other may be bended at a dummy cell of a non display area S2 or a predetermined location of the non display area S2 where no dummy cell is present.

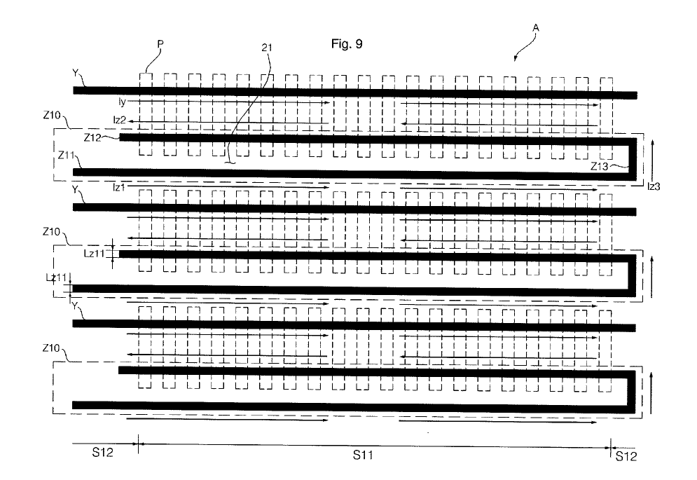

FIG. 9 is a magnified view of a first block A of FIG. 7 in accordance with the second embodiment of the present invention.

Since the plasma display panel 200 of FIG. 9 according to the second embodiment has the electrode arrangement of scan electrode and sustain electrode similar to the electrode arrangement of FIG. 8, only differences therebetween will be described.

Referring to FIG. 9, a sustain electrode Z10 includes a first electrode unit Z11 extending on a barrier rib 21 from a driver 170 disposed one side to a non display area S12 disposed at the other side, a second electrode unit Z12 extending on a discharge cell P10 adjacent to an upper side or a lower side of the barrier rib 21 from the non display area S12 to the driver 170, and a coupling unit Z13 for connecting the first and second electrode units Z11 and Z12.

Here, the first electrode unit Z11 is formed to have lower brightness than the second electrode unit Z12 and the coupling unit Z13.

Also, a width Lz11 of the first electrode unit Z11 is substantially identical to a width Lz12 of the second electrode unit Z12.

That is, the first electrode unit Z11 substantially has a black color. The first electrode unit Z11 is formed on the barrier rib 21 for performing the function of black matrix (not shown).

That is, the first electrode unit Z11 block light by absorbing external light generated from the outside and improves purity and contrast of an upper substrate (not shown). Therefore, it is possible to substitute the first electrode unit Z11 for the black matrix.

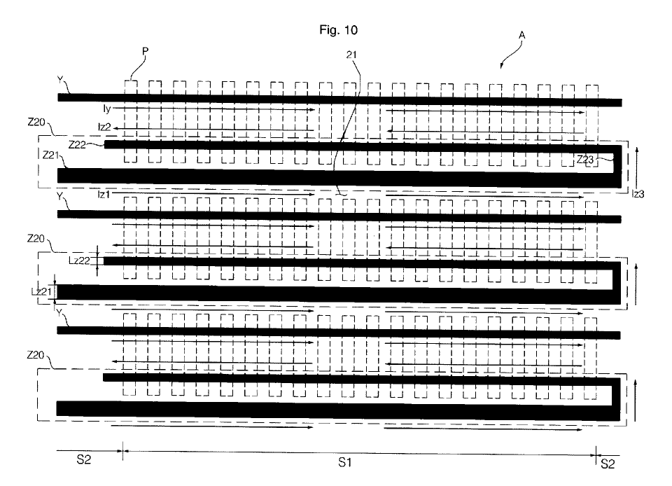

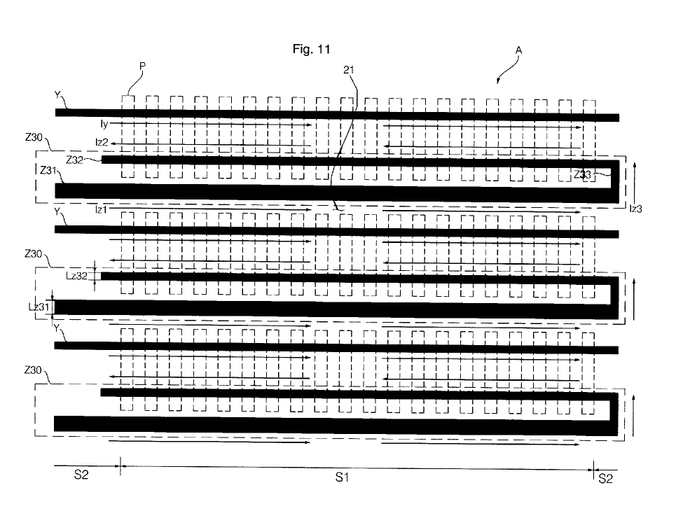

FIG. 10 is a magnified view of a first block A of FIG. 7 in accordance with the third embodiment of the present invention, and FIG. 11 is a magnified view of a second block B of FIG. 7 in accordance with the fourth embodiment of the present invention.

Since the plasma display panel 200 according to the third embodiment shown in FIG. 10 has the electrode arrangement of the scan electrode and the sustain electrode similar to that shown in FIG. 8, only differences therebetween will be described.

As shown in FIG. 10, the sustain electrode Z20 includes a first electrode unit Z21, a second electrode unit Z22, and a coupling unit Z23.

A width Lz21 of the first electrode unit Z21 is formed to be wider than a width Lz22 of the second electrode Z22. A width Lz23 of the coupling unit Z23 is formed to be equal to or smaller than the width Lz21 of the first electrode unit Z21. Also, the width Lz23 of the coupling unit Z23 is formed to be equal to or wider than the width Lz22 of the second electrode unit Z22.

That is, it is preferable that the width Lz21 of the first electrode unit Z21 is about 1.2 times or 1.9 times of the width Lz22 of the second electrode Z22. Among sustain current lz applied to the driver 170, the first sustain current lz1 and the second sustain current lz2 substantially have the identical current value by forming the width Lz21 of the first electrode unit Z21 wider than the width Lz22 of the second electrode unit Z22.

In other word, the resistance component of the first electrode unit Z21 can be reduced by forming the width Lz21 of the first electrode unit Z21 to be wider than the width Lz22 of the second electrode Z22.

Since the plasma display panel 200 of FIG. 11 has an electrode arrangement structure similar to that shown in FIG. 10, only differences therebetween will be described.

As shown in FIG. 11, the sustain electrode Z30 includes a first electrode unit Z31, a second electrode unit Z32, and a coupling unit Z23.

Here, a width Lz31 of the first electrode unit Z31 is formed to be wider than a width Lz32 of the second electrode unit Z32, and a width of the coupling unit Z33 is formed to be equal to or narrower than the width Lz31 of the first electrode unit Z31, and to be equal to or wider than the width Lz32 of the second electrode unit Z32.

The first electrode unit is formed to have brightness lower than that of the second electrode unit Z32. Since it was already described in detail with FIG. 9, detail description thereof is omitted.

That is, the first electrode unit Z31 substantially has black color and is formed on the barrier rib 21 for performing the same function of a black matrix (not shown).

The first electrode unit 31 performs a light block function for reducing reflection by absorbing an external light generated from the outside and improves the purity and contrast of an upper substrate (not shown). Therefore, it is possible to substitute the first electrode unit Z31 for the black matrix.

The first electrode unit Z3 may be formed with only a bus electrode. That is, it is because that the first electrode unit Z31 may be substituted with the black matrix.

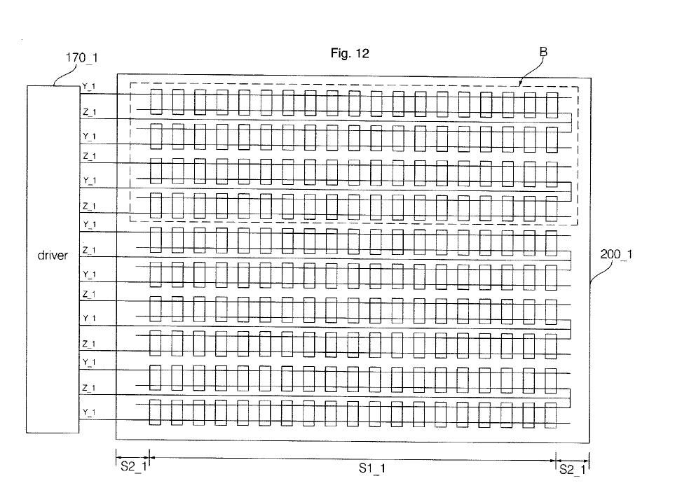

FIG. 12 is a perspective view illustrating electrode arrangement of a plasma display electrode in accordance with the second embodiment of the present invention.

As shown in FIG. 12, the plasma display device according to the present embodiment a plasma display panel 200_1 and a driver 170_1. The plasma display panel 200_1 includes an upper substrate having a scan electrode Y_1 and a sustain electrode Z_1 and a lower substrate having a barrier rib for dividing discharge cells. The driver 170_1 is disposed at one side of the plasma display panel 200_1 and applies a driving signal to the scan electrode Y_1 and the sustain electrode Z_1.

The driver 170_1 shown in FIG. 12 is equivalent to the integrated driving board 70 having the printed circuit board 40 shown in FIG. 6. Hereinafter, it will be described as the driver 170_1.

The driver 170_1 is disposed at a rear side of the plasma display panel 200_1. FIG. 12 is a plane view of the drive 170_1.

The driver 170_1 is disposed at one side of the plasma display panel 200_1 and applies a driving signal to the scan electrode Y_1 and the sustain electrode Z_1.

The plasma display panel 200_1 includes a display area S1_1 where an image is displayed and a non display area S2_1 where an image is not displayed. The non display area S2_1 surrounds the display area S1_1.

One of the scan electrode Y_1 and the sustain electrode Z_1 extends on the barrier rib from the driver 170_1 formed at one side of the plasma display panel 200_1 to the non display area S2_1 disposed at the other side thereof, bends at the non display area S2_1, and extends to discharge cells adjacent to an upper side and a lower side of the barrier rib.

That is, current flows in the scan electrode Y_1 and the sustain electrode Z_1 in different directions on the discharge cells adjacent to the upper side and the lower side of the barrier rib.

In other word, a direction of current flow in the scan electrode Y_1 is from the driver 170_1 formed at one side to the non display area S2_1 formed at the other side, and a direction of current flow in the sustain electrode Z_1 is from the non display area S2_1 formed at the other side to the driver 170_1 of one side on the discharge cell adjacent to the upper side or the lower side of the barrier rib.

Such electrode arrangement of the scan electrode Y_1 and the sustain electrode Z_1 can reduce brightness deviation between a discharge cell adjacent to the driver 170_1 formed at one side and a discharge cell adjacent to the non display area S2_1 formed at the other.

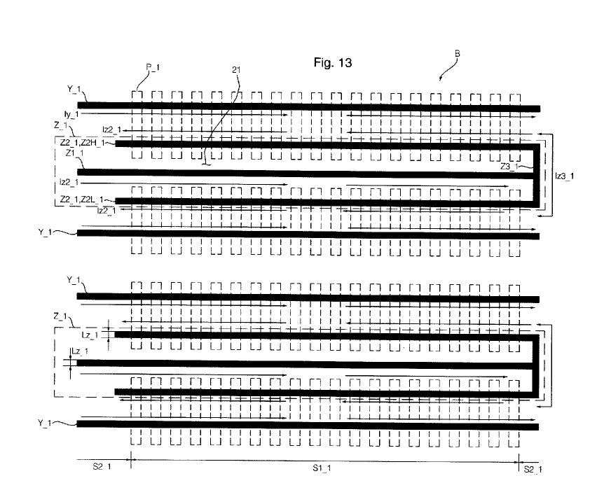

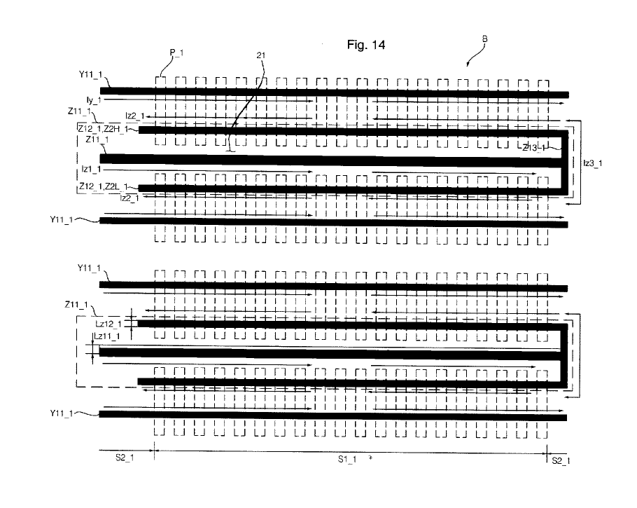

FIG. 13 is a magnified view of a second block B of FIG. 12 in accordance with the first embodiment of the present invention, and FIG. 14 is a magnified view of a second block B of FIG. 12 in accordance with the second embodiment of the present invention.

As shown in FIG. 13, the plasma display panel 200_1 includes a scan electrode Y_1 and a sustain electrode Y_1. The scan electrode Y_1 extends on a discharge cell P_1 from the driver 170_1 disposed at one side of the plasma display panel 200_1 to a non display area S2_1 disposed at the other side thereof. The sustain electrode Y_1 extends on the barrier rib 21 from the driver 170_1 to the non display area S2_1 disposed at the other side, bends at the non display area S2_1, and extends again on a discharge cell P_1 adjacent to an upper side or a lower side of the barrier rib 21 to the driver 170_1.

That is, the sustain electrode Z_1 includes a first electrode unit Z1_1 extending on the barrier rib 21 from the driver 170_1 to the non display area S2_1 disposed at the other side, a second electrode unit Z2_1 extending on a discharge cell P_1 adjacent to the upper side and the lower side of the barrier rib 21 from the non display area S2_1 to the driver 170_1, and a coupling unit Z3_1 for connecting the first and second electrode units Z1_1 and Z2_1.

The second electrode unit Z2_1 includes a first electrode line Z2H_1 extending to a discharge cell P_1 adjacent to an upper side of the barrier rib 21, and a second electrode line Z2L_1 extending to a discharge cell P_1 adjacent to a lower side of the barrier rib 21.

The driver 170_1 applies a scan current ly_1 to the scan electrode Y_1 and applies a sustain current lz_1 to the sustain electrode Z_1.

The sustain current lz_1 includes a first sustain current lz_1 flowing to the first electrode unit Z1_1, a second sustain current lz2_1 flowing to the second electrode unit Z2_1, and a third sustain current lz3_1 flowing to the coupling unit Z3_1.

Although the sustain current lz_1 was described to include the first, second, and third sustain current lz1_1, lz2_1, and lz3_1 for convenience, the first, second, and third sustain currents lz1_1, lz2_1, and lz3_1 are the sustain current lz_1.

The first, second, and third sustain currents lz1_1, lz2_1, and lz3_1 flow in different directions, and the first sustain current lz1_1 flows the same direction of the scan current ly_1.

Therefore, a current flow direction of the second sustain current lz2_1 is opposite to that of the scan current ly_1.

The width of the scan electrode Y_1 and the width Lz_1 of the sustain electrode Z_1 are formed to be substantially equal, or a width of the first electrode Z1_1 is identical to a width Lz_1 of the second electrode Z2_1.

The electrode arrangement of the scan electrode Y_1 and the sustain electrode Z_1 have a Y-ZZ-Y structure on a discharge cell P_1.

Here, the scan electrode Y_1 and the sustain electrode Z_1 are formed to have the same brightness.

A bus electrode, a transparent electrode, and a black matrix are formed at the scan electrode Y_1 and the second electrode Z2_1 of the sustain electrode Z_1, respectively.

The first electrode unit Z1_1 of the sustain electrode Z_1 may be formed as the bus electrode and the black matrix.

Also, the first electrode unit Z1_1 may have brightness lower than the second electrode unit Z2_1, the coupling unit Z3_1, and the scan electrode Y_1. Accordingly, the first electrode unit Z1_1 may be formed only with the bus electrode on the barrier rib 21.

That is, the first electrode unit Z1_1 has black color which has brightness substantially lower than the second electrode unit Z2_1. The first electrode unit Z1_1 is formed on the barrier rib 21 and may perform the light blocking function for reducing reflection by absorbing an external light generated from the outside and improves the purity and contrast of an upper substrate (not shown). Therefore, it is possible to substitute the first electrode unit Z1_1 for the black matrix.

Although the second electrode unit Z2_1 was described to have two first and second electrode lines Z2H_1, and Z2L_1 in the present embodiment, the second electrode unit Z2_1 may include less than five electrode lines.

If the second electrode unit Z2_1 include more than six electrode lines, the sustain current lz_1 applied to the first electrode unit Z1_1 may be lost due to the resistance of each electrode line. Therefore, it is preferable to include less than five electrode lines.

Since the plasma display panel 200_1 according to the present embodiment shown in FIG. 14 has the electrode arrangement of the scan electrode Y_1 and the sustain electrode Z_1 similar to that shown in FIG. 12, only differences therebetween will be described.

In FIG. 14, the sustain electrode Z11_1 includes a first electrode unit Z11_1, a second electrode unit Z12_1, and a coupling unit Z13_1.

The first electrode unit Z11_1 is formed to have a width Lz11_1 wider than a width Lz12_1 of the second electrode unit Z12_1.

As described above, resistance component can be reduced by forming the width Lz1_1 of the first electrode unit Z1_1 larger than the width Lz2_1 of the second electrode unit Z2_1. Therefore, it is possible to reduce the loss of the sustain current lz_1 applied to the driver 170_1.

Also, the first electrode unit Z11_1 may be formed to have brightness lower than or equal to that of the second electrode unit Z12_1. Since it was already described in detail with reference to FIG. 10 and FIG. 11, detail description thereof is omitted.

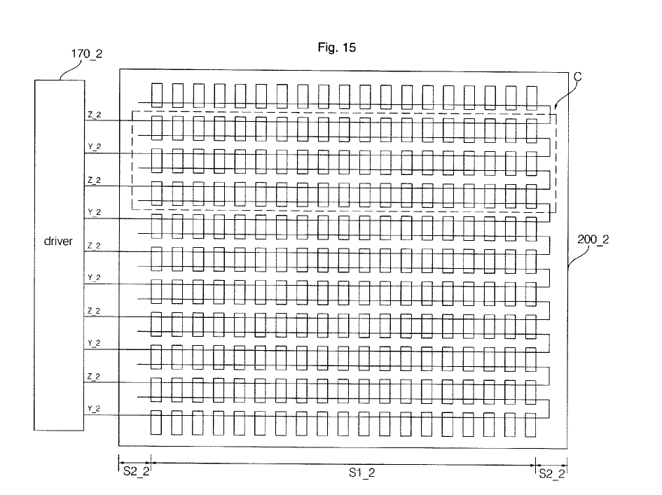

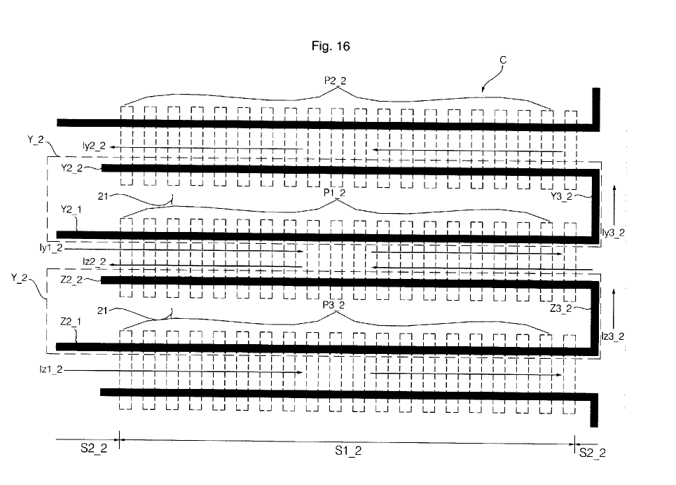

FIG. 15 is a perspective view of electrode arrangement of a plasma display device in accordance with the third embodiment of the present invention. FIG. 16 is a magnified view of a third block C of FIG. 15 in accordance with a first embodiment of the present invention.

As shown in FIG. 15, the plasma display device according to the present embodiment includes a plasma display panel 200_2 and a driver 170_2. The plasma display panel 200_2 includes an upper substrate having a scan electrode Y_2 and a sustain electrode Z_2 and a lower substrate having a barrier rib that divide discharge cells. The driver 170_2 is disposed at one side of the plasma display panel 200_2 and applies a driving signal to the scan electrode Y_2 and the sustain electrode Z_2.

The driver 170_2 of FIG. 15 is equivalent to the integrated driving board 70 having the printed circuit board 40 shown in FIG. 6. Hereinafter, it is referred as the driver 170_2.

The driver 170_2 is disposed at a rear side of the plasma display panel 200_2. FIG. 15 is a plane view thereof.

The driver 170_2 is formed at one side of the plasma display panel 200_1 and applies a driving signal to the scan electrode Y_2 and the sustain electrode Z_2.

The plasma display panel 200_2 includes a display area S1_2 where an image is displayed and a non-display area S2_2 where an image is not displayed. The non display area S2_2 surrounds the display area S1_2.

The scan electrode Y_2 extends on a first discharge cell from the driver 170_2 formed at one side of the plasma display panel 202_2 to the non display area S2_2 disposed at the other side, bends at the non display area S2_2, and extends on a second discharge cell to the driver 170_2.

The sustain electrode Z_2 extends on a third discharge cell from the driver 170_2 formed at one side of the plasma display panel 200_2 to the non display area S2_2 disposed at the other side, bends at the non display area S2_2, and extends on the first discharge cell to the driver 170_2.

That is, current flows in the scan electrode Y_2 and the sustain electrode Z_2 in different directions on the first discharge cell.

In more detail, on the first discharge cell, the direction of current flowing on the scan electrode Y_2 is from the driver 170_2 disposed at one side to the non display area S2_2 disposed at the other side, and the direction of current flowing on the sustain electrode Z_2 is from the non display area S2_2 disposed at the other side to the driver 170_2 disposed at one side.

Therefore, it is possible to reduce brightness deviation between a discharge cell adjacent to the driver 170_2 and another discharge cell adjacent to the non display area S2_2 disposed at the other side.

As shown in FIG. 15 and FIG. 16, the plasma display panel 200_2 includes a scan electrode Y_2 and a sustain electrode Z_2. The scan electrode Y_2 extends on the first discharge cell P1_2 from the driver 170_2 disposed at one side to the non display area S2_2 disposed at the other side, bends at the non display area S2_2, and extends again on the second discharge cell P2_2 to the driver 170_2. The sustain electrode Z_2 extends on a third discharge cell P3_2 from the driver 170_2 to the non display area S2_2 disposed at the other side, bends at the display area S2_2, and extends again on the first display area S2_2 to the driver 170_2.

That is, the scan electrode Y_2 includes a first electrode unit Y12 extending on the first discharge cell P12 from the driver 170_2 to the non display area S2_2 disposed at the other side, a second electrode unit Y2_2 extending on the second discharge cell P2_2 from the non display area S2_2 to the driver 170_2, and a coupling unit Y3_2 for connecting the first and second electrode units Y1_2 and Y2_2.

Also, the sustain electrode Z_2 includes a first electrode unit Z1_2 extending on the third discharge cell P3_2 from the driver 17u0)2 to the non display area S2_2 disposed on the other side, a second electrode unit Z2_2 on the first discharge cell P1_2 from the non display area S2_2 to the driver 170_2, and a coupling unit Z3_2 for connecting the first and second electrode units Z1_2 and Z2_2.

The driver 170_1 applies a scan current ly_2 to the first electrode unit Y1_2 of the scan electrode Y_2 and a sustain current lz_2 to the first electrode unit Z1_2 of the sustain electrode Z_2.

Here, the scan current ly_2 includes a first scan current ly1_2 flowing to the first electrode unit Y1_2, a second scan current ly1_2 flowing to the second electrode unit Y2_2, and a third scan current ly3_2 flowing to the coupling unit Y3_2.

The sustain current lz_2 includes a first sustain current lz1_2 flowing to the first electrode unit Z1_2, a second sustain current lz2_2 flowing to the second electrode unit Z2_2, and a third sustain current lz3_2 flowing to the coupling unit Z3_2.

Although the scan current ly_2 and the sustain current lz_2 were described to include the first, second, and third scan currents ly1_2, Iy2_2, and Iy3_2, and the first, second, and third sustain currents Iz1_2, Iz2_2, and Iz3_2, respectively, the first, second, and third scan currents ly1_2, Iy2_2, and Iy3_2, and the first, second, and third sustain currents Iz1_2, Iz2_2, and Iz3_2 are the scan current ly_2 and the sustain current lz_2. The scan current ly_2 and the sustain current lz_2 were described to include the first, second, and third scan currents ly1_2, ly2_2, and Iy3_2, and the first, second, and third sustain currents Iz1_2, Iz2_2, and Iz3_2 for convenience.

Here, the current flow directions of the first, second, and third scan current Iy1_2, Iy2_2, and Iy3_2 are different to each others. Also, the current flow direction of the first, second, and third sustain current Iz1_2, Iz2_2, and Iz3_2 are different to each others.

However, the first scan current ly1_2 flows in the same direction of the second sustain current lz2_2, the second scan current ly2_2 flows in the same direction of the first sustain current lz1_2, and the third scan current ly3_2 flows the same direction of the third sustain current lz3_2.

The scan electrode Y_2 and the sustain electrode Z_2 has an electrode arrangement structure Y-ZZ-Y, and the widths thereof may be the same or different to each other.

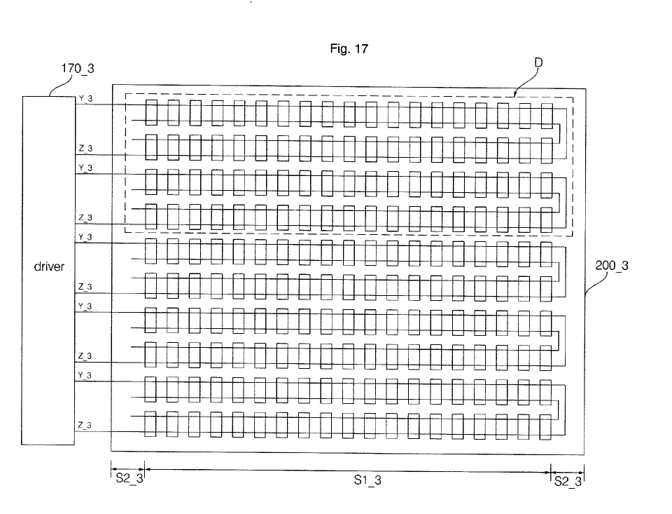

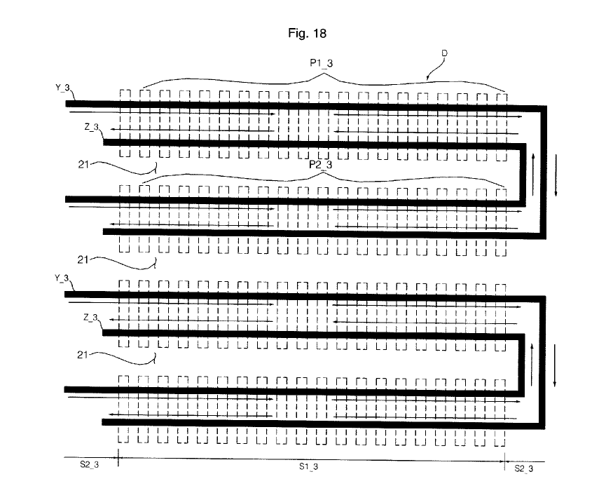

FIG. 17 is a perspective view illustrating electrode arrangement of a plasma display device in accordance with the fourth embodiment of the present invention, and FIG. 18 is a magnified view of a fourth block D of FIG. 17.

As shown in FIG. 17, the plasma display device according to the present embodiment includes a plasma display panel 200_3 and a driver 170_3. The plasma display panel 200_3 includes an upper substrate having a scan electrode Y_3 and a sustain electrode Z_3 and a lower substrate having a barrier rib for dividing discharge cells. The driver 170_3 is disposed at one side of the plasma display panel 200_3 and applies a driving signal to the scan electrode Y_3 and the sustain electrode Z_3.

Since the plasma display device of FIG. 17 has the similar structure of the plasma display device of FIG. 15, only differences therebetween will be described.

A scan electrode Y_3 extends on a first discharge cell from the driver 170_3 disposed at one side of the plasma display panel 200_3 to a non display area S2_3 disposed at the other side, bends at the non display area S2_3, and extends again on a second discharge cell to the driver 170_3.

Also, a sustain electrode Z_3 extends on the second discharge cell from the driver 170_3 disposed at one side of the plasma display device 200_3 to the non display area S2_3 disposed at the other side thereof, bends at the non display area S2_3, and extends on the first discharge cell to the driver 170_3.

That is, on the first discharge cell, current flows in different direction on the scan electrode Y_3 and the sustain electrode Z_3.

In more detail, on the first discharge cell, a direction of current flow in the scan electrode Y_3 is from the driver 170_3 disposed at one side to the non display area S2_3 disposed at the other side, and a direction of current flow in the sustain electrode Z_3 is from the non display area S2_3 disposed at the other side to the driver 170_3 disposed at one side.

As shown in FIG. 18, the plasma display panel 200_3 includes a scan electrode Y_3 and a sustain electrode Z_3. The scan electrode Y_3 extends on a first discharge cell P1_3 from the driver 170_2 disposed at one side to the non display area S2_3 disposed at the other side, bends at the non display area S2_3, and extends again on the second discharge cell P2_3 to the driver 170_3. The sustain electrode Z_3 extends on the second discharge cell P2_3 from the driver 170_3 to the non display area S2_3 disposed at the other side, bends at the non display area S2_3, and extends again on the first discharge cell P1_3 to the driver 170_3.

That is, although the electrode arrangement of FIG. 18 has the similar shape of the electrode arrangement shown in FIG. 16 in a structural view, the electrode arrangement may have a structure in which the scan electrode Y_3 surrounds the sustain electrode Z_3 or the sustain electrode Z_3 surrounds the scan electrode Y_3.

In the plasma display devices according to the first to fourth embodiments, at least one of the scan electrode and the sustain electrodes formed at the plasma display panel is formed to be bent. Here, a gap at a bending start part is different from a gap at a bending end part. Although the scan and sustain electrodes were described to be bent at a predetermined angle, the scan and sustain electrodes may be formed in a semicircle shape.

Also, the gap of the bending start part may be formed to be larger than that of the bending end part.

The plasma display device according to the present invention can reduce connection between at least one of the scan electrode and the sustain electrode and the driver by half. Therefore, it is possible to reduce the use of a driver IC and to improve the efficiency of a manufacturing process.

Also, the plasma display device according to the present invention can reduce brightness deviation between discharge cells adjacent to a driver and another discharge cells adjacent to a non display area disposed at the opposite side of the driver in a plurality of discharge cells included in the plasma display panel.

The foregoing exemplary embodiments and aspects of the invention are merely exemplary and are not to be construed as limiting the present invention. The present teaching can be readily applied to other types of apparatuses. Also, the description of the exemplary embodiments of the present invention is intended to be illustrative, and not to limit the scope of the claims, and many alternatives, modifications, and variations will be apparent to those skilled in the art.

What is claimed is:

1. A plasma display device comprising:
a plasma display panel including an upper substrate having a scan electrode and a sustain electrode, and a lower substrate having a barrier rib for dividing discharge cells; and
a driver disposed at one side of the plasma display panel and applying a driving signal to the scan electrode and the sustain electrode,
wherein at least one of the scan electrode and the sustain electrode includes:
a first electrode unit extending on the barrier rib from the driver to a non display area disposed at the other side of the plasma display panel; and
a second electrode unit connected to the first electrode unit and extending from the non display area to the driver on discharge cells that are adjacent to an upper side and a lower side of the barrier rib,
wherein current flows in the scan electrode and the sustain electrode in opposite directions on the discharge cells.

2. The plasma display device of claim 1, wherein a width of the first electrode unit is wider than a width of the second electrode unit.

3. The plasma display device of claim 1, wherein a width of the first electrode unit is about 1.2 times or about 1.9 times of a width of the second electrode unit.

4. The plasma display device of claim 1, wherein the first electrode unit has brightness lower than brightness of the second electrode unit.

5. The plasma display device of claim 1, wherein the first electrode unit substantially has black color.

6. The plasma display device of claim 1, wherein no black matrix is formed on the barrier rib.

7. The plasma display device of claim 1, wherein the second electrode unit includes a bus electrode and a transparent electrode, and the first electrode unit is constituent of only a bus electrode.

8. The plasma display device of claim 1, wherein the second electrode unit includes:
a first electrode line extending on a discharge cell adjacent to an upper side of the barrier rib; and
a second electrode line extending on a discharge cell adjacent to a lower side of the barrier rib.

9. The plasma display device of claim 1, wherein two sustain electrodes are continuously disposed between adjacent two scan electrodes.

10. The plasma display device of claim 1, further comprising: a coupling unit formed at a non display area of the plasma display panel and connecting the first and second electrode units,
wherein a width of the coupling unit is wider than the width of the second electrode unit.

11. The plasma display device of claim 1, wherein the second electrode unit includes a plurality of electrode lines extending on different discharge cells from the non display area to the driver,
wherein the number of the plurality of electrode lines is less than 5.

12. A plasma display device comprising:
a plasma display panel including an upper substrate having a scan electrode and a sustain electrode and a lower substrate having a barrier rib dividing discharge cells; and
a driver disposed at one side of the plasma display panel and applying a driving signal to the scan electrode and the sustain electrode,
wherein the scan electrode and the sustain electrode include:
a first electrode unit extending from the driver to a non display area disposed at the other side of the plasma display panel; and
a second electrode unit connected to the first electrode unit and extending from the non display area to the driver,
wherein current flows in the scan electrode and the sustain electrode in opposite directions on the discharge cells.

13. The plasma display device of claim 12, wherein the first electrode unit extends on a first discharge cell from the driver to a non display area disposed at the other side of the plasma display panel, and the second electrode unit extends on second discharge cells adjacent to an upper side or a lower side of the first discharge cell from the non display area to the driver.

14. The plasma display device of claim 12, wherein two sustain electrodes are continuously disposed between two adjacent scan electrodes.

15. The plasma display device of claim 12, wherein the first electrode unit of the scan electrode and the second electrode unit of the sustain electrode are formed on one discharge cell.

16. The plasma display device of claim 12, wherein the first and second electrode units of at least one of the scan electrode and the sustain electrode are disposed between the first and second electrodes of the other.

17. A plasma display device comprising:
a plasma display panel including an upper substrate having a scan electrode and a sustain electrode and a lower substrate having a barrier rib for dividing discharge cells; and
a driver disposed at one side of the plasma display panel and applying a driving signal to the scan electrode and the sustain electrode,
wherein at least one of the scan electrode and the sustain electrode includes:
a first electrode unit extending from the driver to a non display area disposed at the other side of the plasma display panel; and
a second electrode unit connected to the first electrode unit and extending from the non display area to the driver,
wherein two sustain electrodes are continuously disposed between two adjacent scan electrodes, and current flows in the scan electrode and the sustain electrode in opposition directions on the discharge cells.

18. The plasma display device of claim 17, wherein the first electrode unit is formed on the barrier rib, and the second electrode unit includes a first electrode line extending on a discharge cell adjacent to an upper side of the barrier rib and a second electrode line extending on a discharge cell adjacent to a lower side of the barrier rib.

19. The plasma display device of claim 18, wherein a width of the first electrode unit is about 1.2 times or 1.9 times of a width of the second electrode unit.

20. The plasma display device of claim 17, wherein the first electrode unit extends on a first discharge cell from the driver to a non display area disposed at the other side of the plasma display panel, the second electrode unit extends on a second discharge cell adjacent to an upper side or a lower side of the first discharge cell from the non display area to the driver, and each of the scan electrode and the sustain electrode includes the first and second electrodes.
